(19) United States
(12) Patent Application Publication
(10) Pub. No.: US 2008/0002600 A1
(43) Pub. Date: Jan. 3, 2008

(54) Power saving control apparatus and method for portable terminal capable of accessing wireless LAN and mobile communication system

(75) Inventor: Jong-Mu Choi, Gunpo-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/801,563

(22) Filed: May 10, 2007

(30) Foreign Application Priority Data
Jun. 29, 2006 (KR) 10-2006-0059101

(51) Int. Cl. G08C 17/00

(52) U.S. Cl. 370/311

(57) ABSTRACT

Provided are a power saving control apparatus and method for a portable terminal. The apparatus includes a telephone communicator communicating with a base station (BS) to receive access point (AP) nearest BS (AnB) information from the BS; a wireless LAN communicator communicating with an AP, wherein if a mode setting event occurs, a mode determiner determines a power mode of the wireless LAN communicator depending on whether the wireless LAN communicator is accessing the AP, the telephone communicator is accessing the BS, and an AP the wireless LAN communicator is capable of accessing is positioned within a cell coverage area of the BS during the access to the BS; a power supply unit for the wireless LAN communicator; and a power manager controlling the power supply unit according to the power mode determined by the mode determiner.

### PRIORITY

This application claims priority under 35 U.S.C. § 119 to an application filed in the Korean Intellectual Property Office on Jun. 29, 2006 and assigned Serial No. 2006-59101, the contents of which are incorporated herein by reference.

### BACKGROUND OF THE INVENTION

1. Field of the Invention

The present invention relates generally to a power saving control apparatus and method for a portable terminal capable of accessing a wireless local area network (LAN) and a mobile communication system, and in particular, to a power saving control apparatus and method for a portable terminal capable of receiving from a base station (BS) information about an access point (AP) included in the BS to determine whether a wireless LAN is accessible, and for periodically supplying or cutting off a power source according to the determination.

2. Description of the Related Art

With the rapid development of the portable electronic equipment including portable computers and mobile telephones, studies have been made on applying wireless access schemes to wired networks such as Intranets or the Internet and the World Wide Web (WWW) in recent years.

A wireless local area network (LAN) is known as an efficient technique for accessing a wired network at low cost and high speed. A 3^{rd} generation (3G) mobile communication system, such as Code Division Multiple Access (CDMA) 2000, a Wideband Code Division Multiple Access/Universal Mobile Telecommunications System (WCDMA/UMTS), a General Packet Radio System (GPRS), and CDMA 2000 1*EVDV(EVolution Data and Voice), realizes a high-speed data transmission through a wireless channel to enable a mobile station or user equipment to access a packet communication network such as the Internet through a cellular mobile communication network.

However, using up-to-date wireless access technology results in high costs. Thus, there have been increased demands for studying, developing, and standardizing activities for linking a mobile communication network to a wireless LAN through a mobile station which can access both the mobile communication network and the wireless LAN. The major object of the linkage is to provide services of the mobile communication network using the wireless LAN, which is low-priced and has a high capacity.

Different from a mobile communication network, an Institute Electrical and Electronics Engineers (IEEE) 802.11-based wireless LAN does not use an additional paging channel through which an accessible network node, i.e., an access point (AP), can be tracked. An operation of detecting an accessible AP is called a scan, wherein the operation is performed by an IEEE 802.11-based mobile station. There are two methods for a scan of a wireless LAN. The first method is an active scan. In the active scan, a terminal transmits a probe signal for scanning near APs, and an AP, which has received the probe signal, responds to the terminal using a response signal including a plurality of parameters necessary for an access. Thus, the terminal can confirm an accessible AP. If the terminal uses the active scan, the terminal may further quickly detect accessible APs. However, a user must determine whether an AP is positioned in a near area to manually activate a wireless LAN unit. Thus, the active scan may be inconvenient to the user. According to a passive scan as the second method, APs broadcast beacon signals once at every time interval of hundreds of ms, and a terminal receives the beacon signals to confirm accessible APs. A beacon signal includes various kinds of parameters that a terminal requires to try an access to a wireless LAN. Thus, a terminal, which has received the beacon signal, may try an access to a corresponding AP. In the case of the passive scan, a wireless LAN terminal can be automatically connected to an AP so as to reduce inconvenience for a user. However, the wireless LAN terminal must be continuously powered on. Thus, even when a wireless LAN communicator is not in an access, power may be wasted.

In the case of an IEEE 802.11-based wireless LAN, it is very difficult for a terminal to detect an accessible wireless LAN AP. In other words, if APs of a wireless LAN operate in different frequency bands, a wireless LAN terminal must transmit probe signals to available frequency channels to detect all APs (in the case of the active scan) or must detect available frequency channels to receive beacon signals of a plurality of frequency channels (in the case of the passive scan). This means that time required for detecting the APs of the wireless LAN is increased. If the wireless LAN terminal continuously performs scanning to detect the wireless LAN as described above, power of the wireless LAN terminal may be soon exhausted.

Accordingly, there are provided an apparatus and a method for supplying power to perform scanning and connecting operations only if there is a possibility of a portable terminal being connected to an AP.

### SUMMARY OF THE INVENTION

An aspect of the present invention is to substantially solve at least the above problems and/or disadvantages and to provide at least the advantages below. Accordingly, an aspect of the present invention is to provide a power saving control apparatus and method for a portable terminal capable of accessing a wireless local area network (LAN) and a mobile communication system.

Another aspect of the present invention is to provide a power saving control apparatus and method for a portable terminal capable of controlling and saving power supplied to a wireless LAN communicator and of accessing a wireless LAN and a mobile communication system.

A further aspect of the present invention is to provide a power saving control apparatus and method for a portable terminal capable of receiving from a base station (BS) information of an access point (AP) positioned within a cell coverage area of the BS to determine whether a wireless LAN is accessible so as to determine whether power is to be supplied to a wireless LAN communicator.

The above aspects are achieved by providing a power saving control apparatus and method for a portable terminal capable of accessing a wireless LAN and a mobile communication system.

According to one aspect of the present invention, there is provided a power saving control apparatus for a portable terminal capable of accessing a wireless local area network (LAN) and a mobile communication system. A telephone communicator may communicate with a base station (BS) to receive access point (AP) nearest BS (AnB: AP Nearest Base Station) information from the BS. A wireless LAN communicator may communicate with an AP. If a mode setting event occurs, a mode determiner may determine a power mode of the wireless LAN communicator depending on whether the wireless LAN communicator is accessing the AP, the telephone communicator is accessing the BS, and an AP whereto the wireless LAN communicator is capable of accessing is positioned within a cell coverage area of the BS during the access to the BS. A power supply unit may supply power to the wireless LAN communicator. A power manager may control the power supply unit according to the power mode determined by the mode determiner to manage the power supplied to the wireless LAN communicator.

According to another aspect of the present invention, there is provided a power saving control method for a portable terminal capable of accessing a wireless LAN and a mobile communication system. If a mode setting event occurs, whether a wireless LAN communicator is accessing an AP will be determined. If it is determined that the wireless LAN communicator is not accessing the AP, next whether a telephone communicator is accessing a BS will be determined. If it is determined that the telephone communicator is accessing the BS, whether an accessible AP is positioned within a cell coverage of the BS will be determined from AnB (AP Nearest Base Station) information received from the BS. If it is determined that the accessible AP is positioned within the cell coverage of the BS, a power mode may be set to a power saving mode.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a wireless local area network (LAN) and a mobile communication system network to which a portable terminal is capable of access, according to the present invention;

FIG. 2 is a block diagram of a power saving control apparatus for a portable terminal capable of accessing a wireless LAN and a mobile communication system according to the present invention; and

FIG. 3 is a flowchart of a power saving control method for a portable terminal capable of accessing a wireless LAN and a mobile communication system according to the present invention.

### DETAILED DESCRIPTION OF THE PREFERRED EMBODIMENTS

Preferred embodiments of the present invention will be described herein below with reference to the accompanying drawings. In the following description, well-known functions or constructions are omitted for clarity and conciseness.

The present invention provides a power saving control apparatus and method for a portable terminal capable of receiving from a base station (BS) information about an access point (AP) positioned within a cell coverage area of in the BS to determine whether a wireless local area network (LAN) is accessible so as to periodically supply or cut off a power source, according to the determination, for accessing the wireless LAN and a mobile communication system.

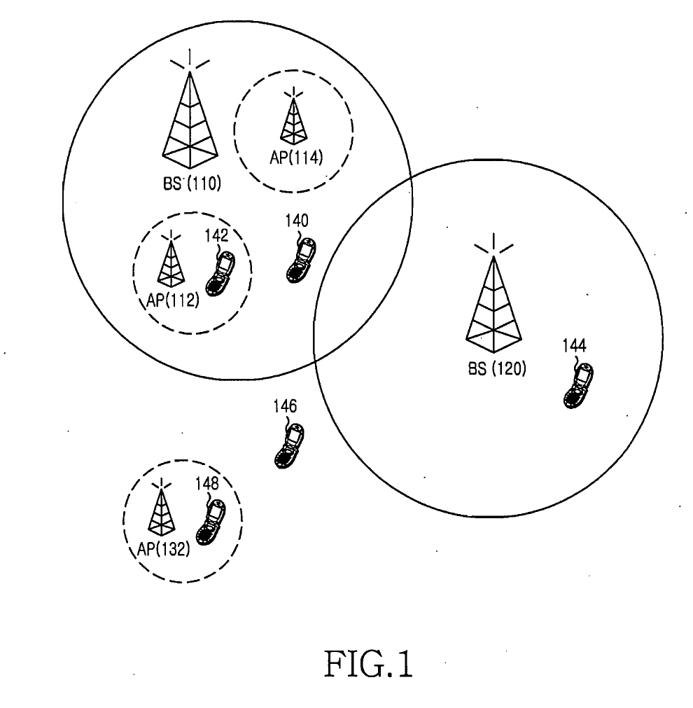

FIG. 1 illustrates a wireless LAN and a mobile communication system network to which a portable terminal is capable of access, according to the present invention.

Referring to FIG. 1, zones represented by solid line circles denote cell coverage areas of BSs 110 and 120, and zones represented by dotted line circles denote service coverage areas of APs 112, 114, and 132.

If the BS 110 of the present invention includes the APs 112 and 114 within the cell coverage areas, the BS 110 broadcasts information of the APs 112 and 114 at fixed time intervals within the cell coverage areas. Portable terminals 140, 142, and 144, which are currently accessing the BSs 110 and 112, can confirm whether the BSs 110 and 120 include the APs 112 and 114. In other words, the portable terminals 140, 142, and 144, which are currently accessing the BSs 110 and 120, can determine whether they are capable of accessing the APs 112 and 114.

In the present invention, a power supply mode, a power saving mode, and a power cut-off mode defined in IEEE 802.11 standards, i.e., three power managing modes for a wireless LAN communicator, are used to save power. Here, the power supply mode is a mode in which the power is continuously supplied to the wireless LAN communicator. The power saving mode is a mode in which the power is repeatedly supplied to and then cut off from the wireless LAN communicator at fixed time intervals. The power cut-off mode is a mode in which the power is not supplied to the wireless LAN communicator. The IEEE 802.11 standards define that a current mode is manually changed into the power supply mode, the power saving mode, or the power cut-off mode by a user. Thus, this manual change may be very inconvenient to the user. However, in the present invention, a terminal automatically changes the current mode according to accessibility of the terminal to at least one of a BS and an AP.

If a power managing mode defined in the present invention is applied to portable terminals of FIG. 1, portable terminals 142 and 148, which are currently accessing the APs 112 and 132, respectively, operate in the power supply mode of the wireless LAN communicator. The portable terminal 140, which is currently accessing the BS 110 including the APs 112 and 114 but is not accessing the APs 112 and 114, may access the APs 112 and 114. Thus, the portable terminal 140 operates in the power saving mode. A portable terminal 146, which is not accessing the BSs 110 and 120 or the APs 112, 114, and 132, may access the AP 132 which is not included in the BSs 110 and 120. Thus, the portable terminal 146 operates in the power saving mode. Or the portable terminal 146 may operate in the power supply mode in the case that fast connection speed is needed The portable terminal 144, which is accessing the BS 120 not including an AP, may not access an AP during the access to the BS 120. Thus, the portable terminal 144 operates in the power cut-off mode.

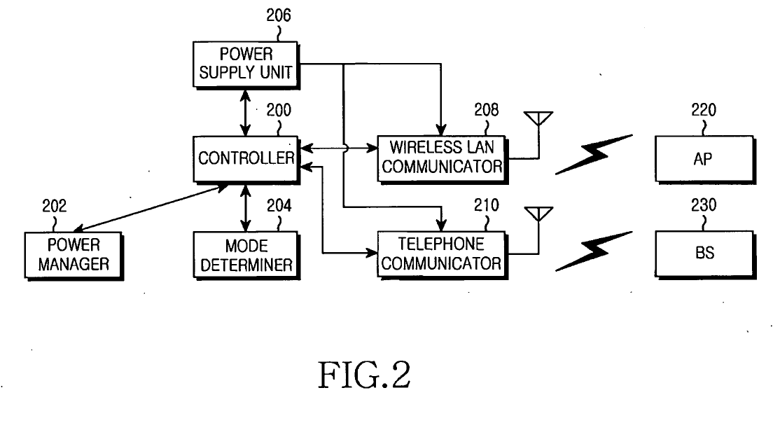

FIG. 2 is a block diagram of a power saving control apparatus for a portable terminal capable of accessing a wireless LAN and a mobile communication system according to the present invention. Referring to FIG. 2, the portable terminal according to the present embodiment includes a controller 200, a power manager 202, a mode determiner 204, a power supply unit 206, a wireless LAN communicator 208, and a telephone communicator 210.

The power manager 202 controls the controller 200 according to a power mode determined by the mode determiner 204 to supply or cut off power to the wireless LAN communicator 208. If the power mode determined by the mode determiner 204 is a power supply mode, the power manager 202 controls the power supply unit 206 to supply continuous power to the wireless LAN communicator 208. If the power mode is a power saving mode, the power manager 202 controls the power supply unit 206 to repeatedly supply then cut off power to the wireless LAN communicator 208 at fixed time intervals. If the power mode is a power cut-off mode, the power manager 202 controls the power supply unit 206 to cut off power to the wireless LAN communicator 208.

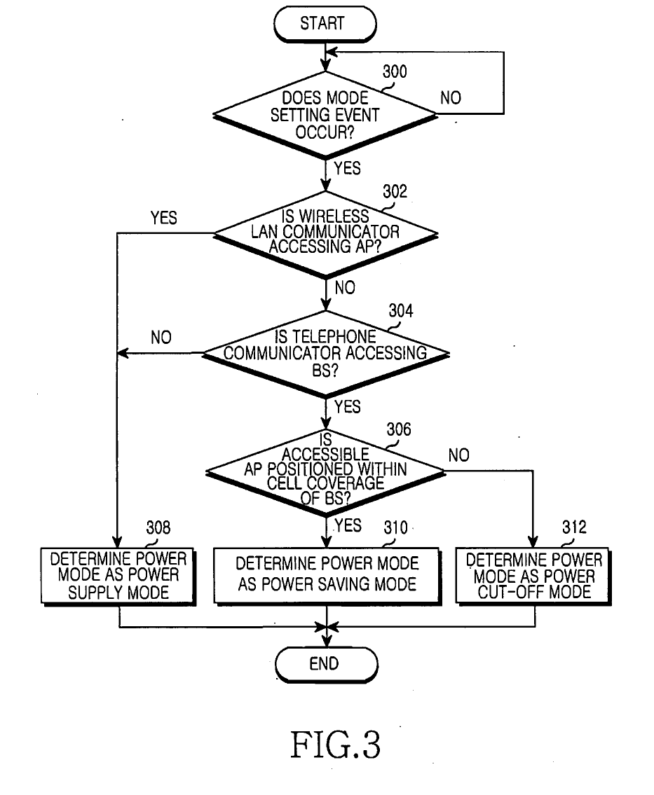

If a mode setting event occurs, the mode determiner 204 determines the power mode of the wireless LAN communicator 208 depending on whether the wireless LAN communicator 208 is accessing an AP, e.g. AP 220, and whether the telephone communicator 210 is accessing a BS, e.g. BS 230. Here, the mode setting event occurs when there is a change in accessibility of the wireless LAN communicator 208 to the AP 220 or of the telephone communicator 210 to the BS 230. A criterion for the mode determiner 204 in determining the power mode will be described in detail later with reference to FIG. 3.

The controller 200 controls functions of the power manager 202 and the mode determiner 204. In the present invention, the power manager 202 and the mode determiner 204 are constituted separately from the controller 200 for the purpose of clearly describing the functions of the power manager 202 and the mode determiner 204. Thus, if a product is substantially realized, both the power manager 202 and the mode determiner 204 may be controlled by the controller 200. Alternatively, only one of the power manager 202 and the mode determiner 204 may be controlled by the controller 200.

The power supply unit 206 supplies power to the portable terminal. According to the present invention, the power supply unit 206 is controlled by the power manager 202 to supply power to the wireless LAN communicator 208.

When the wireless LAN communicator 208 is supplied with power from the power supply unit 206, the wireless LAN communicator 208 searches for an AP, e.g. the AP 220, to which it is capable of accessing, using a passive scan and then, if found, accesses the AP 220 to transmit and/or receive data according to IEEE 802.11 standards.

The telephone communicator 210 communicates with the BS 230 to transmit and/or receive data. According to the present invention, the telephone communicator 210 receives AP nearest BS (AnB) information broadcast by the BS 230 and provides the AnB information to the mode determiner 204. The BS 230 communicating with the telephone communicator 210 broadcasts information of the APs included in the BS 230 cell coverage area, including AnB information, at fixed time intervals.

A power saving control method for a portable terminal capable of accessing a wireless LAN and a mobile communication system will now be described with reference to the flowchart of FIG. 3.

In step 300, the power saving control apparatus for the portable terminal according to the present invention determines whether a mode setting event occurs when there is a change in accessibility of the wireless LAN communicator 208 to the AP 220 or of the telephone communicator 210 to the BS 230. If it is determined in step 300 that the mode setting event occurs, the power saving control apparatus proceeds to step 302 to determine whether the wireless LAN communicator 208 is accessing the AP 220. If it is determined in step 302 that the wireless LAN communicator 208 is accessing the AP 220, the power saving control apparatus goes to step 308 to determine a power mode as a power supply mode so as to supply continuous power to the wireless LAN communicator 208.

However, if it is determined in step 302 that the wireless LAN communicator 208 is not accessing the AP 220, the power saving control apparatus proceeds to step 304 to determine whether the telephone communicator 210 is accessing the BS 230. If it is determined in step 304 that the telephone communicator 210 is not accessing the BS 230, the power saving control apparatus goes to step 308 to determine the power mode as the power supply mode so as to supply continuous power the wireless LAN communicator 208. FIG. 3. Or in this case the power mode may be power saving mode in the case that efficient power use rather than fast connection is needed.

If it is determined in step 304 that the telephone communicator 210 is accessing the BS 230, the power saving control apparatus proceeds to step 306 to receive AnB information from the BS 230 so as to determine whether an accessible AP is positioned within the cell coverage of the BS 230. If it is determine in step 306 that the accessible AP is positioned within the cell coverage area of the BS 230, the power saving control apparatus proceeds to step 310 to determine the power mode as a power saving mode so as to repeatedly supply then cut off the power to the wireless LAN communicator 208 at fixed time intervals.

If it is determined in step 306 that the accessible AP is not positioned within the cell coverage of the BS 230, the power saving control apparatus goes to step 312 to determine the power mode as a power cut-off mode so as not to supply the power to the wireless LAN communicator 208.

As described above, in a power saving control apparatus and method for a portable terminal capable of accessing a wireless LAN and a mobile communication system according to the present invention, information of an AP included in a BS can be received from the BS to determine whether the wireless LAN is accessible. Thus, a determination as to whether power is to be supplied to a wireless LAN communicator can be made. As a result, power to the terminal can be saved.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A power saving control apparatus for a portable terminal capable of accessing a wireless local area network (LAN) and a mobile communication system, comprising:
a telephone communicator communicating with a base station (BS) to receive access point (AP) nearest BS (AnB) information from the BS;
a wireless LAN communicator communicating with an AP,
wherein if a mode setting event occurs, a mode determiner determines a power mode of the wireless LAN communicator depending on whether the wireless LAN communicator is accessing the AP, whether the telephone communicator is accessing the BS, and whether an AP to which the wireless LAN communicator is capable of accessing is positioned within a cell coverage area of the BS during an access of the telephone communicator to the BS;
a power supply unit supplying power to the wireless LAN communicator; and
a power manager controlling the power supply unit according to the power mode determined by the mode determiner to manage power supplied to the wireless LAN communicator.

2. The power saving control apparatus of claim 1, wherein the BS broadcasts the AnB information at fixed time intervals and the AnB information comprises information of an AP positioned within a cell coverage area of the BS.

3. The power saving control apparatus of claim 1, wherein when there is a change in accessibility of the wireless LAN communicator to the AP or of the telephone communicator to the BS, the mode determiner determines that the mode setting event occurs.

4. The power saving control apparatus of claim 1, wherein if the wireless LAN communicator is accessing the AP, the mode determiner determines the power mode as a power supply mode.

5. The power saving control apparatus of claim 4, wherein the power supply mode determined by the mode determiner is a mode for continuously supplying power to the wireless LAN communicator.

6. The power saving control apparatus of claim 1, wherein if the wireless LAN communicator is not accessing the AP, and the telephone communicator is accessing the BS including an accessible AP positioned within the cell coverage area of the BS, the mode determiner determines the power mode as a power saving mode.

7. The power saving control apparatus of claim 6, wherein the power saving mode determined by the mode determiner is a mode for repeatedly supplying then cutting off power to the wireless LAN communicator at fixed time intervals.

8. The power saving control apparatus of claim 1, wherein if the wireless LAN communicator is not accessing the AP, and the telephone communicator is accessing the BS that has no accessible AP within the cell coverage area of the BS, the mode determiner determines the power mode as a power cut-off mode.

9. The power saving control apparatus of claim 8, wherein the power cut-off mode determined by the mode determiner is a mode for cutting off power supplied to the wireless LAN communicator.

10. A power saving control method for a portable terminal capable of accessing a wireless local area network (LAN) and a mobile communication system, comprising:
if a mode setting event occurs, determining whether a wireless LAN communicator is accessing an access point (AP);
if it is determined that the wireless LAN communicator is not accessing the AP, determining whether a telephone communicator is accessing a base station (BS);
if it is determined that the telephone communicator is accessing the BS, determining from access point (AP) nearest BS (AnB) information received from the BS whether an accessible AP is positioned within a cell coverage area of the BS; and
if it is determined that the accessible AP is positioned within the cell coverage area of the BS, setting a power mode to a power saving mode.

11. The power saving control method of claim 10, wherein the power saving mode is a mode for repeatedly supplying then cutting off power to the wireless LAN communicator of the portable terminal at fixed time intervals.

12. The power saving control method of claim 10, after determining whether the accessible AP is positioned within the cell coverage area of the BS, further comprising: if it is determined that the accessible AP is not positioned within the cell coverage area of the BS, setting the power mode to a power cut-off mode.

13. The power saving control method of claim 12, wherein the power cut-off mode is a mode for cutting off power supplied to the wireless LAN communicator of the portable terminal.

14. The power saving control method of claim 10, after determining whether the wireless LAN communicator is accessing the AP, further comprising: if it is determined that the wireless LAN communicator is accessing the AP, setting the power mode to a power supply mode.

15. The power saving control method of claim 14, wherein the power supply mode is a mode for continuously supplying the power to the wireless LAN communicator of the portable terminal.

16. The power saving control method of claim 10, wherein the BS broadcasts the AnB information at fixed time intervals and the AnB information comprises information of an AP positioned within the cell coverage area of the BS.

17. A portable communication terminal for power saving control capable of accessing a wireless local area network (LAN), comprising:
a telephone communicator for communicating with a base station (BS) to receive access point (AP) nearest BS (AnB) information from the BS;
a wireless LAN communicator for communicating with an AP; and
a mode determiner for determining a power mode of the wireless LAN communicator depending on whether the wireless LAN communicator is accessing the AP, whether the telephone communicator is accessing the BS, and whether an AP to which the wireless LAN communicator is capable of accessing is positioned within a cell coverage area of the BS during an access of the telephone communicator to the BS.

18. A power saving control method for a portable communication terminal capable of accessing a wireless local area network (LAN) and a mobile communication system, comprising:
identifying from access point (AP) nearest BS (Base Station) information (AnB information) received from the BS whether an accessible AP is positioned within a cell coverage area of the BS when a telephone communicator is accessing a base station (BS) and a wireless LAN communicator is not accessing the AP; and
setting a power mode to a power saving mode if the accessible AP is positioned within the cell coverage area of the BS.

19. The power saving control method of claim 18, wherein the BS broadcasts the AnB information at fixed time intervals and the AnB information comprises information of an AP positioned within the cell coverage area of the BS.

20. A portable communication terminal for power saving control capable of accessing a wireless local area network (LAN) and a mobile communication system, comprising:
means for identifying from access point (AP) nearest BS (Base Station) information (AnB information) received from the BS whether an accessible AP is positioned within a cell coverage area of the BS when a telephone communicator is accessing a base station (BS) and a wireless LAN communicator is not accessing the AP; and
means for setting a power mode to a power saving mode if the accessible AP is positioned within the cell coverage area of the BS.
